(19) United States
(12) Patent Application Publication
(10) Pub. No.: US 2007/0160020 A1
(43) Pub. Date: Jul. 12, 2007

(54) Interleaved wireless mesh network

(76) Inventor: Robert Osann, Cupertino, CA (US)

Correspondence Address: FLIESLER MEYER LLP, 650 CALIFORNIA STREET, 14TH FLOOR, SAN FRANCISCO, CA, 94108, US

(21) Appl. No.: 11/503,036

(22) Filed: Aug. 11, 2006

Related U.S. Application Data
(60) Provisional application No. 60/756,794, filed on Jan. 5, 2006.

(51) Int. Cl. H04Q 7/24

(52) U.S. Cl. 370/338

(57) ABSTRACT

An interleaved wireless mesh network is described where each mesh node always has at least two radios that have access to at least two parallel meshes, and where a packet stream may utilize either or both of these parallel meshes for any given hop, using the parallel (physical) meshes as a single (logical) mesh. Here, two sequentially adjacent packets in a particular packet stream may travel on the same mesh or on different meshes for any given hop, thereby enabling the performance of a specific sequential packet stream to be doubled. Dynamic frequency selection (DFS) operations can be performed by the parallel meshes upon sensing radar interference on a channel used by either mesh. While one mesh is performing the DFS, packets may continue to be propagated on the alternative mesh, thereby enabling continuous and uninterrupted data flow throughout the network.

### CLAIM OF PRIORITY

This application claims the benefit and priority of U.S. Provisional Application Ser. No. 60/756,794, filed on Jan. 5, 2006, and entitled “DIRECTIONAL AND INTERLEAVED WIRELESS MESH NETWORKS,” commonly assigned with the present application and incorporated herein by reference.

### CROSS REFERENCES TO RELATED APPLICATIONS

This application is related to and cross references the following U.S. patent applications, which are incorporated herein by reference:

U.S. patent application Ser. No. 11/507,921 entitled “INTERLEAVED AND DIRECTIONAL WIRELESS MESH NETWORK,” by Robert Osann, Jr., filed on Aug. 22, 2006, Attorney Docket No. OSAN-01003US0.

U.S. patent application Ser. No. 11/516,995 entitled “SYNCHRONIZED WIRELESS MESH NETWORK,” by Robert Osann, Jr., filed on Sep. 7, 2006, Attorney Docket No. OSAN-01005US0.

U.S. patent application Ser. No. 11/592,805 entitled “COMBINED DIRECTIONAL AND MOBILE INTERLEAVED WIRELESS MESH NETWORK,” by Robert Osann, Jr., filed on Nov. 3, 2006, Attorney Docket No. OSAN-01006US0.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates generally to the field of wireless mesh networks for public safety and general public access applications.

### BACKGROUND OF THE INVENTION

Typical wireless mesh networks use a single radio for the backhaul or relay function where packets are moved through the mesh from node to node. This causes a significant bandwidth limitation since a single radio cannot send and receive at the same time. Adding relay radios at individual mesh nodes can enable a mesh node to simultaneously send and receive packets, thereby increasing the overall rate of bandwidth propagation through the mesh node. The simplest form of prior art mesh network is the ad hoc mesh network shown in FIG. 1(a), where each mesh node 101 contains a relay radio 102. This is the most elemental form of wireless mesh network and originated in the military. It was characteristic of these networks that all mesh nodes have a single radio and all radios operate on the same channel or frequency.

Note that in this specification, the term “channel” is most often used to mean a specific RF frequency or band of frequencies. However, the term “channel” is to be understood in a generalized sense as designating a method of isolating one data transmission from others such that they do not interfere. While this differentiation or isolation may be accomplished by utilizing different frequencies, it may also be accomplished by choosing different RF wave polarizations or in the case of a TDMA scheme, it may refer to different time slots in a time division scheme. For CDMA systems, isolation of transmissions may result from having different spreading codes. Regardless, channelization is a method for making efficient use of available spectrum and preventing interference between different transmissions that otherwise might interfere with each other.

One evolution of the early ad hoc mesh network form is shown in FIG. 1(b) where relay radio 103 is capable not only of transferring packets to adjacent nodes, but is also capable of operating as an access point (AP) as well, providing service (typically WiFi) to client devices such as laptop computers, wireless PDAs, and WiFi VoIP phones.

The architecture of FIG. 1(b) suffers from performance limitations since the single radio must not only relay packets, but also service numerous client radios 104 at each node. Thus, another evolution was developed as shown in FIG. 1(c), where each mesh node has a separate service or AP radio 105 in addition to relay radio 106. This allows client devices 107 to communicate with service radio 105 on a different channel or frequency than relay radio 106, thereby reducing interference effects within the mesh and increasing performance.

A more recent evolution of mesh architectures is shown in FIG. 1(d) where relay radios 108 and 109 are used at each mesh node along with a separate service radio 110. Here, packets can be received on relay radio 108 while simultaneously being transmitted on relay radio 109, and vice versa, thereby increasing performance due to both the simultaneous operation of both radios, as well as the fact that radios 108 and 109 typically operate on different channels, thereby further reducing interference effects in the mesh. It is also known to add radios to the architecture shown in FIG. 1(d) such that there would be two relay radios for uplink replacing relay radio 108, and two relay radios for downlink replacing relay radio 109. This addition effectively doubles the bandwidth and enables full-duplex (simultaneous uplink and downlink) operation, however a specific packet stream will propagate through only one of a pair of uplink or downlink radios. Thus, the maximum performance of such a link between two nodes will only be realized in situations where traffic loading is high. The absolute performance of a single stream of packets will not be increased beyond what a single link could deliver.

While FIG. 1 shows the architectures for various prior art mesh networks in a one-dimensional form for sake of simplicity, FIG. 2 elaborates on the architecture of FIG. 1(d) showing a two-dimensional view. In the 3-radio mesh of FIG. 2, also known as a “structured” mesh, a tree-like structure is formed emanating from a root node 201 which connects directly to a wired network 202. This wired network can, in turn, connect to the Internet or alternatively, it may connect simply to a server. In the case of a public safety network, the wired network will often connect to the Command and Control center. It is characteristic of this type of mesh that, at every hop, packets being relayed travel on a different channel from the previous hop. Thus RF transmissions, 202, 203, and 204 which connect mesh node 201a with mesh nodes 205, 206, and 207, operate on three different channels or frequencies as shown by the different styles of dotted line. In this type of mesh network, the mesh control software on each node has a significant challenge in assigning the various available channels throughout the mesh such that interference effects are minimized, and the mesh functions properly. Some mesh network vendors rely on customers to manually assign channels as the units are being installed. Other mesh vendors have developed very elaborate dynamic channel assignment software programs, which perform this function automatically. Either way, having a mesh network where channels change from hop to hop is complicated and difficult to deal with. In the case of a public safety mesh with mobile nodes (for vehicles and individual First Responders on foot), a further problem arises with this form of mesh. For instance, if a group of first responders each carrying a mesh node become isolated from the backhaul connection to the server (Command and Control), the tree-like structure of FIG. 2 may become compromised since there is no longer a defined root for the tree. It is important for isolated groups of first responders, with nodes that are vehicle mounted, man-carried, or both, to continue communicating amongst themselves when isolated until the connection to Command and Control is restored.

FIG. 3 shows example channel configurations in a WLAN Mesh from section 4.2.3 of IEEE 802.11-06/0328r0, the Combined Proposal for the ESS Mesh Standard (published in March 2006). It should be noted that the publication referenced here post dates the filing of U.S. Provisional Application Ser. No. 60/756,794 to which the present application claims priority. However, in the event that this information had been published in previous submittals at prior IEEE standards meetings, and also for purposes of clarity, the information in this publication is being described herein. FIG. 3(a) shows a simple ad hoc mesh, while FIG. 3(b) shows two ad hoc meshes, 301 and 302, which are bridged by central mesh node 303 having two radios. FIG. 3(c) shows a number of mesh nodes, each having two radios for packet relay, which for the most part are being utilized in a manner similar to the “structured” mesh of FIG. 2. FIG. 3(c) also demonstrates the concept of nodes with 2-radio relays being used to bridge between one sub-mesh and another. This referenced proposal for a new mesh standard also discusses the concept of Unified Channel Graphs or UCGs. In FIGS. 3(d) and 3(e), notice that FIGS. 3(b) and 3(c) are replicated with superimposed circles 304 indicating nodes which communicate with each other on a particular channel. Essentially FIG. 3(e) demonstrates a number of sub-meshes which are bridged by mesh nodes, each bridging node containing two relay radios. One can easily imagine the challenge in assigning channels to the network demonstrated in FIGS. 3(c) and 3(e). Also, when connections between nodes must change because of a node failure, temporary disturbances to the mesh (moving obstacles or radar interference), node movement, or QOS considerations, there can be a ripple effect of changing channels causing even greater complexity.

FIG. 4 shows the architecture for the only mesh network solution that currently supports both public safety and public access, and is being sold by Motorola. Here, there are two completely separate mesh systems embodied in the same enclosure 401. Each enclosure has two radios 402 for public safety and two radios 403 for public access. Each of these separate meshes functions as a “1+1” mesh as demonstrated in FIG. 1(c) by radio elements 105 and 106. This vendor has chosen to make the public access radios utilize 2.4 GHz for both relay and service, with 4.9 GHz being utilized for the public service radios (relay and service). Each of these meshes is separate from the other with no interaction. In particular, packet traffic on the 4.9 GHz mesh may only be used for public service as governed by law—public access traffic may never utilized 4.9 GHz. Thus, this prior art solution addresses the problem that it is desirable to reduce the number of mesh unit enclosures that must be mounted at strategic locations to cover a metropolitan area. However, the solution does not integrate any additional functionality beyond what is shown in FIG. 4, and from a performance standpoint, each of the two individual mesh networks embodied here will have the performance restrictions of other prior art mesh architectures constructed according to FIG. 1(c).

It would therefore be desirable to have a wireless mesh network architecture with the performance characteristics provided by a 2-radio relay, without the complexity of managing multiple and dynamically changeable channels, which can change from hop-to-hop.

### SUMMARY

An interleaved mesh is described that uses at least two relay radios on each node to create two or more simultaneous mesh networks, each on separate channels. A transmitted stream of packets will then utilize any or all of these multiple simultaneous meshes as they propagate through the overall mesh network. For any particular hop, a packet may use any of the available meshes to propagate to the next node. From hop to hop, a particular packet may change which mesh it travels on to reach the next node. Here, two sequential packets in a particular packet stream may travel on the same mesh or on different meshes for any given hop. Two sequential packets can even be transmitted simultaneously from a first node to a second node. Thus, a single stream of sequential packets may be transmitted between two mesh nodes at twice the speed that would normally occur if only a single link were used, or even if multiple links were used but limited to propagating unique streams of packets separately on each link. Therefore, the performance of the highest priority packet stream will be improved regardless of whether traffic loading in the mesh is high or low at the time of transmission.

When two radios are used on a particular node for packet relay according to an interleaved mesh per this invention, data can be received on one radio while simultaneously being sent on the other radio. This circumvents the limitations of a single radio system without requiring complex channel management schemes, while at the same time providing a mesh that can easily operate without a server or internet connection—critically important for Public Safety applications when isolated First Responders are separated from their backhaul connection and must communicate among themselves.

In summary, one object of this invention is to increase performance when packets are relayed through the mesh by providing multiple radios on each node for the relay function. Here, two sequential packets in a particular packet stream may travel on the same mesh or on different meshes for any given hop.

Another object of this invention is to provide multiple radios on each mesh node without requiring a dynamic channel assignment scheme, and thereby utilizing simpler and more mature mesh management software.

Another object of this invention is to provide a more robust mesh architecture where redundant meshes are used between nodes, thereby maintaining an automatic backup path should any disturbance happen to one of the multiple mesh packet propagation paths.

Another object of this invention is to provide an alternative path for packets on a different channel should radar interference occur on one channel causing one of the multiple interleaved meshes to need to change channels, otherwise known as DFS or Dynamic Frequency Selection. Here, when radar interference occurs on a channel of a first mesh of the multiple meshes of an interleaved mesh network, traffic can continue to propagate on a second mesh while the first mesh changes to a different channel. This eliminates the gap in performance that occurs when a DFS change is executed on prior art meshes. Thus all nodes in the system are aware of the number of meshes available and the channels they each utilize.

Another object of this invention is to support mobile public safety mesh, while providing an increased level of performance over traditional mobile mesh with single radio relay.

Another object of this invention is to support mobile mesh nodes with multiple radio relay capability that are able to operate independently as an isolated group, when such groups are isolated from a primary server or command and control connection.

Another object of this invention is to provide a mesh infrastructure with multiple radios that provides higher performance overall for video broadcast distribution and video multicast for video surveillance.

Another object of this invention is to provide an interleaved mesh architecture where WiMax radios could be utilized for the relay function as well as the service radio function for client access.

Another object of this invention is to provide an interleaved mesh architecture where MIMO radios and antennas could be utilized.

### BRIEF DESCRIPTION OF THE DRAWINGS

The present invention is described with respect to particular exemplary embodiments thereof and reference is accordingly made to the drawings in which:

FIG. 1 shows a 1-dimensional view for a variety of prior art mesh network architectures, including both 1-radio relay and 2-radio relay.

FIG. 2 shows a prior art “structured” mesh architecture with 2-radio relay in a 2-dimensional view.

FIG. 3 shows example topologies and channel configurations in a WLAN Mesh from section 4.2.3 of IEEE 802.11-06/0328r0, the recently published Combined Proposal for the ESS Mesh Standard (March 2006).

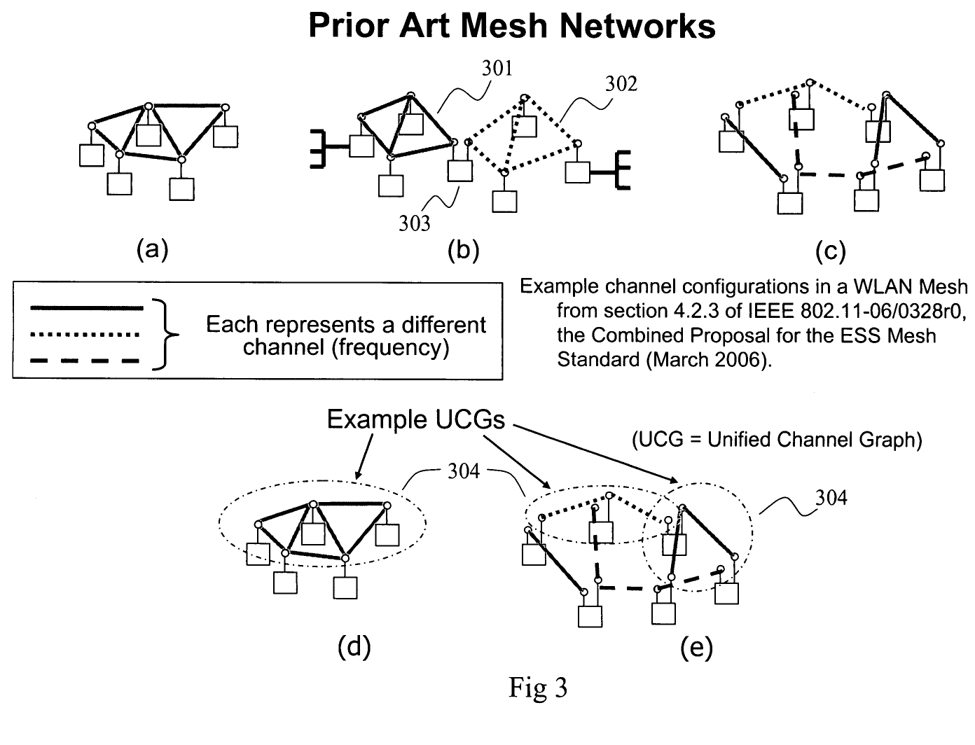

FIG. 4 shows a prior art mesh network which supports both public safety and public access by combining two separate mesh networks in one enclosure, each mesh network supported with one relay radio and a separate AP radio.

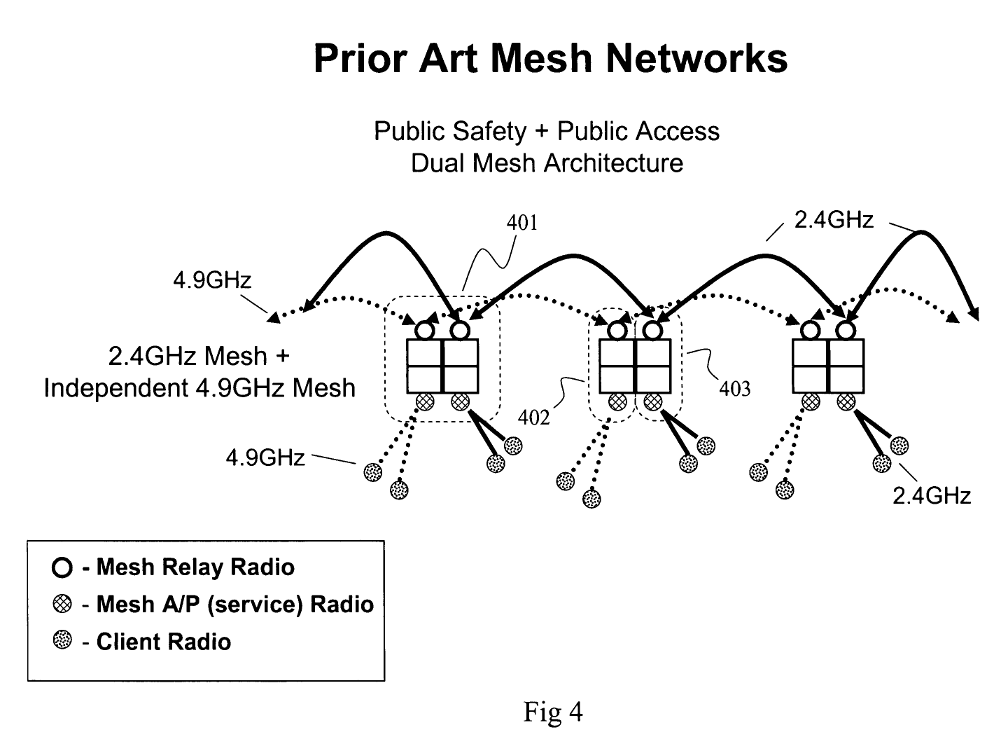

FIG. 5 shows one example of an interleaved wireless mesh network per the present invention, where each mesh node has at least two radios supporting at least two parallel mesh networks that are used in conjunction to propagate a single packet stream.

FIG. 6 shows the interleaved mesh network of the present invention, demonstrating how a single packet stream propagates by using both meshes, traveling on one or the other mesh for any given hop.

FIG. 7 shows the interleaved mesh network of FIG. 6 where a service or AP radio has been added, so that the mesh can communicate with client devices such as laptop computers independent of communications which happen on the relay radios.

FIG. 8 shows some examples of how packets can propagate through an interleaved mesh, ignoring interference affects.

FIG. 9 shows how bandwidth degrades over a one radio relay as a result of adjacent node interference effects.

FIG. 10 shows some examples of how packets can propagate through an interleaved mesh once interference affects are taken into account.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

One of the key components of the present invention is the new functionality herein called interleaved wireless mesh. In an interleaved mesh, at least two physical wireless mesh networks are utilized in parallel to propagate single streams of packets. In other words, a packet being transmitted from a mesh node will always have a choice of two or more meshes on which to propagate to the next mesh node, thus increasing the number of radios which can be simultaneously utilized to propagate a single packet stream. Note that a “packet stream” refers to a specific sequential stream of IP packets. Here, two sequential packets in a particular packet stream may travel on the same mesh or on different meshes for any given hop. Two sequential packets can even be transmitted simultaneously from a first node to a second node. Thus, a single stream of sequential packets may be transmitted between two mesh nodes at twice the speed that would normally occur if only a single link were used, or even if multiple links were used but limited to propagating unique streams of packets separately on each link. Therefore, the performance of the highest priority packet stream will be improved regardless of whether traffic loading in the mesh is high or low at the time of transmission.

Unlike prior art mesh networks with multi-radio relay architectures, the interleaved mesh does not require a complicated channel assignment scheme since typically each of the two meshes connecting to a given mesh node will always be on the same channels from hop to hop. Stated differently, an interleaved mesh can utilize multiple, parallel physical meshes to act like a single logical mesh network. While most examples of interleaved meshes in this specification show two parallel meshes, it should be understood that three or more parallel meshes may also be utilized to form an interleaved mesh according to this invention.

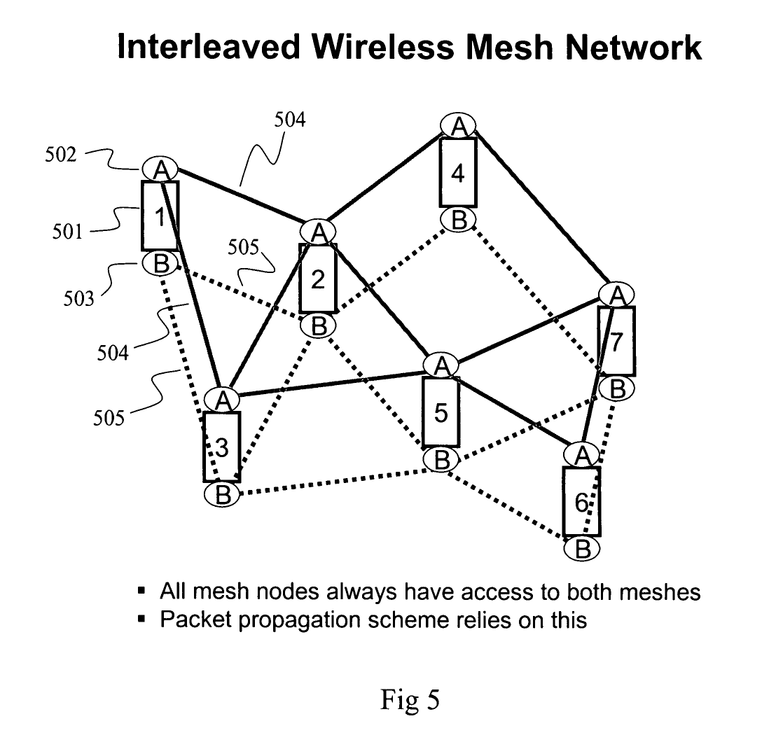

The basic architecture for interleaved mesh is most easily shown for an implementation where omnidirectional antennas are used and each mesh node has only two relay radios. This is demonstrated in FIG. 5 where mesh node 501 has two radios, radio 502 operating on a mesh which uses channel A and radio 503 operating on a mesh which uses channel B. Thus, radio 502 will make RF connections 504 on channel A to nodes 2 and 3, and radio 503 will make RF connections 505 on channel B to nodes 2 and 3. In this embodiment, all mesh nodes always have access to both mesh networks. As will be shown, the packet propagation scheme for an interleaved mesh relies on this fact, and both meshes are utilized to propagate a single packet stream. Since each relay radio in FIG. 5 is typically capable of connecting to all adjacent interleaved mesh nodes as shown, the concept of adjacency is important. For example, in FIG. 5, nodes 1, 3, 4, and 5 would all be considered as adjacent to node 2. Adjacent nodes are those with both physical position and connected RF signal strength so as to make a proper RF connection between them.

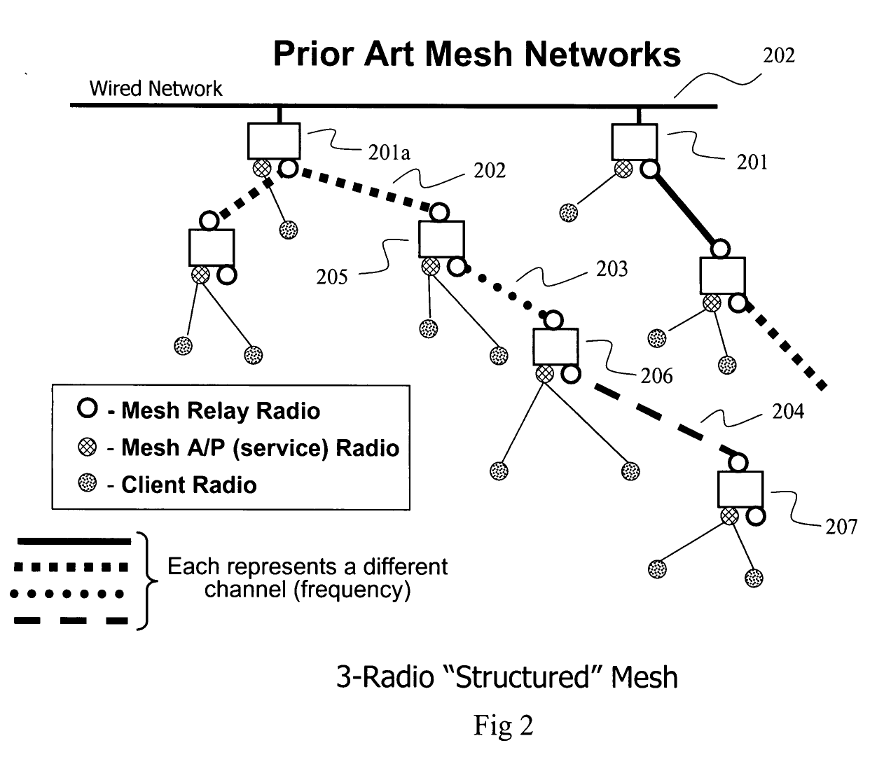

One benefit of having multiple, parallel meshes to propagate packets occurs when DFS (Dynamic Frequency Selection) is required to compensate for radar interference in certain frequency bands. Such a capability is required in a number of countries especially for the 5 GHz band. The European ETSI spec includes a required DFS capability. DFS provides an alternative path for packets on a second channel should radar interference occur on a first channel. The DFS specification as embodied in ETSI EN 301 893 v1.3.1 (August 2005) for the most part assumes a point to multipoint architecture where a single master device (at the hub) acts to control the slave devices relative to frequency channel utilization. However, the specification also states that devices capable of communicating in an ad-hoc manner shall also deploy DFS and should be tested against the requirements applicable to a master device according to the specification. For a conventional prior art mesh network, this means that if one mesh node detects interference on a particular frequency channel, it must notify all other mesh nodes that utilize that channel to change all communications currently operating on that channel to a different channel. For mesh networks with a single radio, single channel relay, this means that there will be an interruption in service during the “channel move time” which according to this specification can be as long as 10 seconds. An interruption of the just a few seconds can destroy a VoIP conversation and cause data losses where data streams back up and overflow data buffers. Even architectures such as that shown in FIG. 2 which include dynamic channel assignment, will have some data interruption while a number of links throughout the mesh are changed to alternate channels.

The interleaved mesh according to this invention handles DFS scenarios while maintaining a level of performance at least 50% as great as the maximum capability. When one of the multiple interleaved meshes according to this invention needs to change channels due to radar or other interference sources, the other mesh (or the others meshes if more than two parallel meshes are used) within the interleaved mesh architecture will continue to carry information during the “channel move time”. Here, when radar interference occurs on the channel of a first mesh of the multiple meshes of an interleaved mesh network, a second mesh can be used to propagate the command which causes other nodes to change channels as well as propagate normal traffic while the first mesh changes to a different channel. This eliminates the gap in performance that occurs when a DFS change is executed on prior art meshes. In order to implement DFS as just described, it is important that all nodes in the system are aware of the number of meshes available and the channels they each utilize.

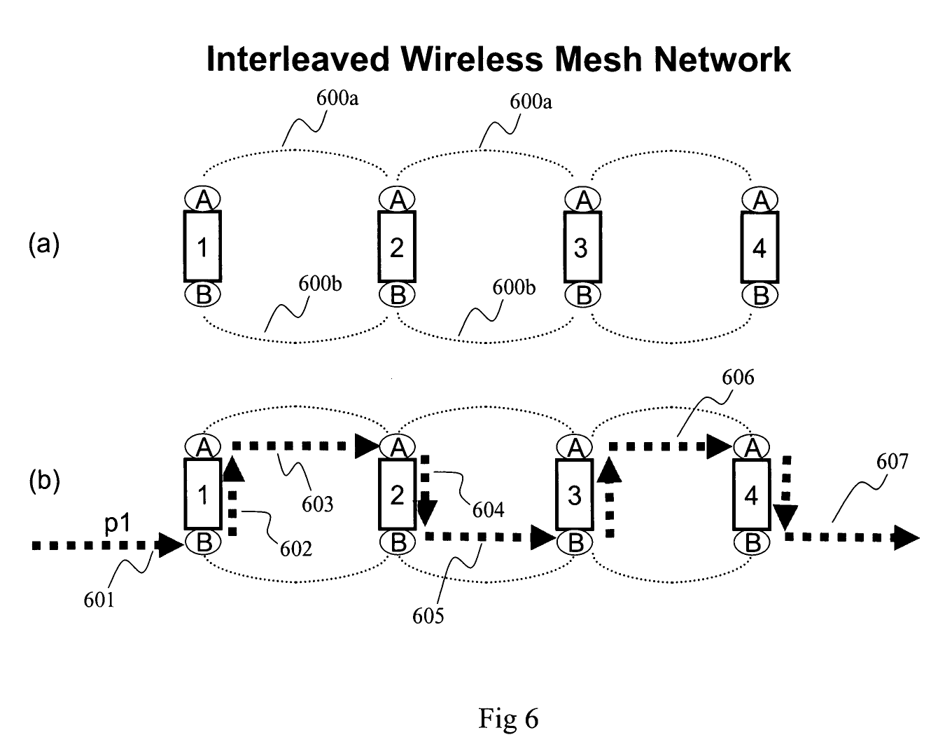

FIG. 6 shows a 1-dimensional architectural generalization for an interleaved wireless mesh according to this invention including a description for one scenario of packet propagation on an interleaved mesh. FIG. 6(a) shows four nodes, each supporting a wireless mesh 600(a) on channel A and another wireless mesh 600(b) on channel B. Omnidirectional antennas are assumed here. However, this should not be construed as limiting the invention and it is noted that the interleaved mesh can also implement directional and/or sector antennas. This four node mesh is shown here in basically a 1-dimensional “string of pearls” topology for sake of simplicity and clarity. It will be understood by those skilled in the art that all mesh networks described in this application can operate in a 2-dimensional mesh topology.

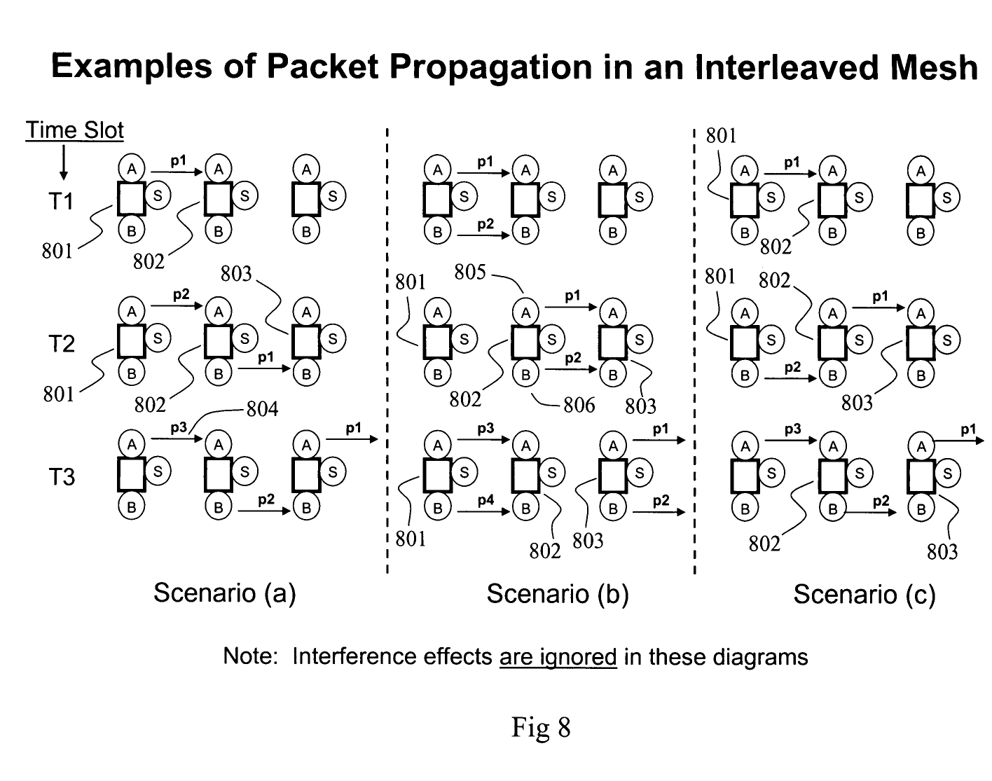

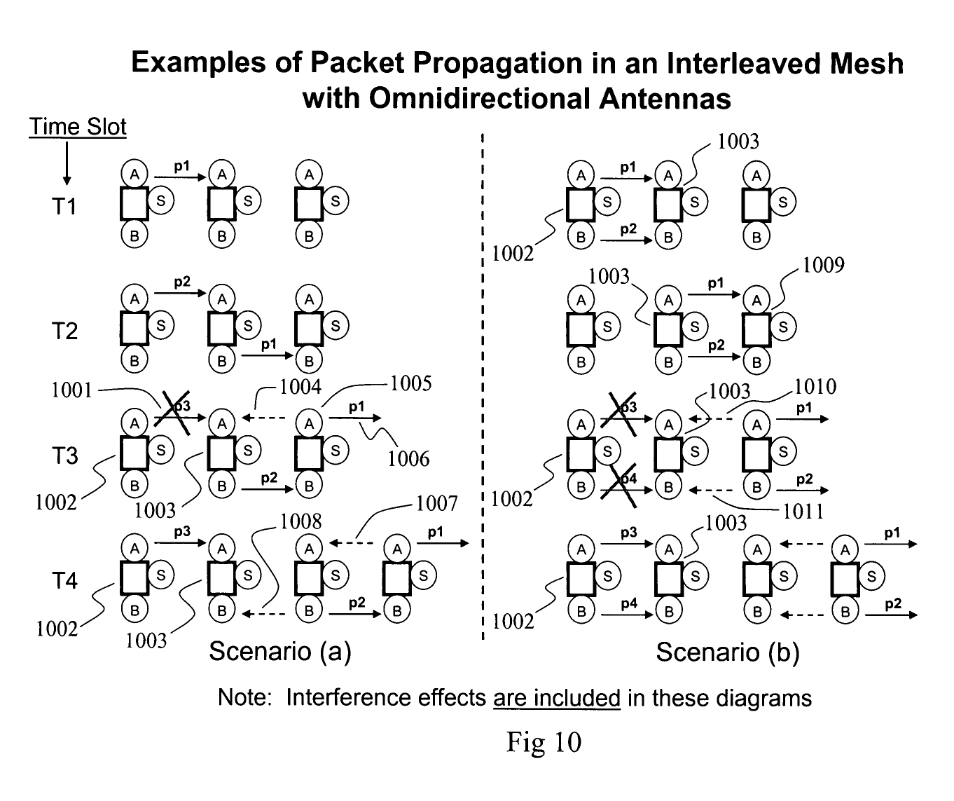

A possible packet propagation scheme for this interleaved mesh scenario is shown in FIG. 6(b) where a single packet p1 starts by entering 601 node 1 on the B-channel mesh. This same packet is then transferred 602 to the A-channel mesh from where it propagates 603 on the A-channel to node 2. The subject packet is then transferred 604 within node 2 back to the B-channel mesh, from where it propagates 605 to node 3. Thus, a single packet may bounce back and forth between one mesh and another mesh in a “ping-pong” or “interleaved” fashion as it propagates through the overall mesh network. At each of the four nodes shown, data can be received through either radio and if the other radio is currently free to transmit, then both radios on a node can be kept busy at the same time if interference effects allow (this will be discussed later). Other variations on packet propagation are possible and will be shown in more detail in FIGS. 8 and 10. Note that nodes with omnidirectional antennas (such as those shown in FIG. 6) can be utilized as mobile nodes, but it should also be apparent to those skilled in the art that such node configurations can be used in either fixed or mobile applications.

As a point of terminology, when a packet is transferred by RF transmission from one node to another, that transfer is referred to as a “hop”. Thus, in FIG. 6, transmissions 601, 603, 605, 606, and 607 all constitute hops, and per the definition of an interleaved mesh per this invention, a single packet may travel on any of multiple physical meshes (in this case the A-channel mesh or the B-channel mesh) for any given hop, as it travels through the overall mesh network.

In a multi-hop wireless mesh network, routing paths are typically planned in a distributed manner, each node determining where it must send a packet in order to move that packet towards an eventual destination. Thus, each node makes a decision for each packet that assigns that packet to a particular routing path. It is therefore very useful if each node has knowledge of other nodes in the network and any constraints that may exist at other points in the network. In other words, if there is a particular node in the network which is currently experiencing bandwidth limitations or an unusual amount of congestion, it is important for other nodes in the system to know this in order to direct packets in a direction that may bypass the impediment. At the same time, if connections between nodes exist in some other area of the mesh where bandwidth is especially high or congestion especially low, this information can also be useful in directing packets along the most optimum routing path. Again it is useful for a particular node to have knowledge of other nodes and connections within the mesh. Therefore in the interleaved mesh network according to the present invention, it is useful for each node to understand which other nodes in the network also have interleaved multi-radio relay capability, in order to plan the most optimum routing path.

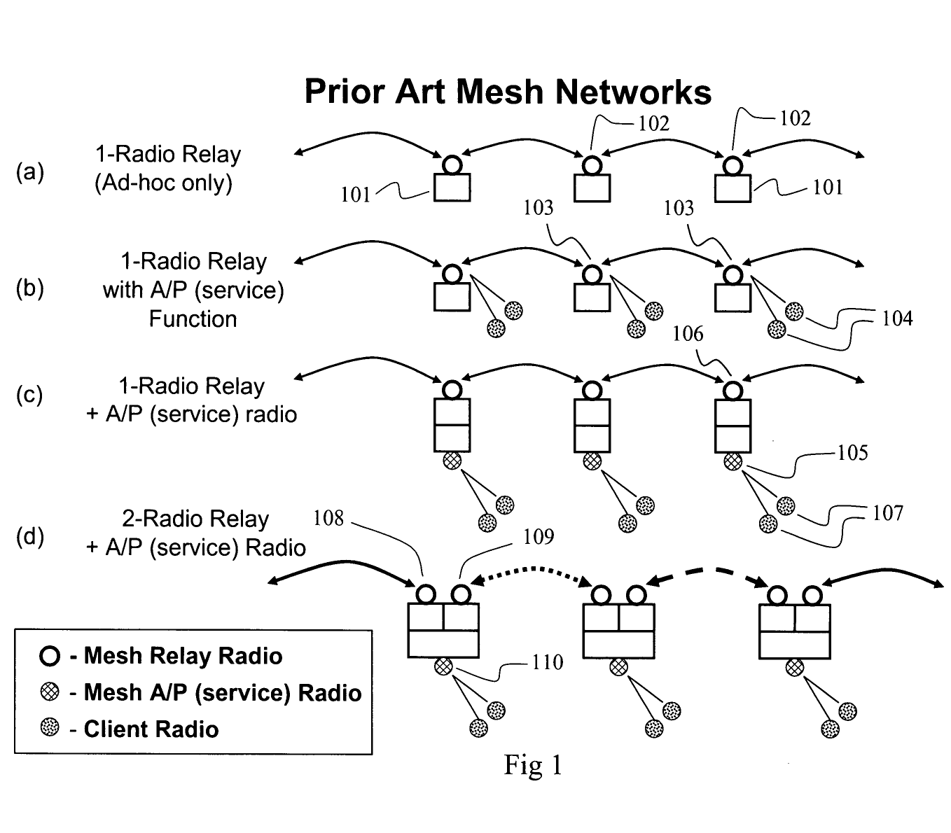

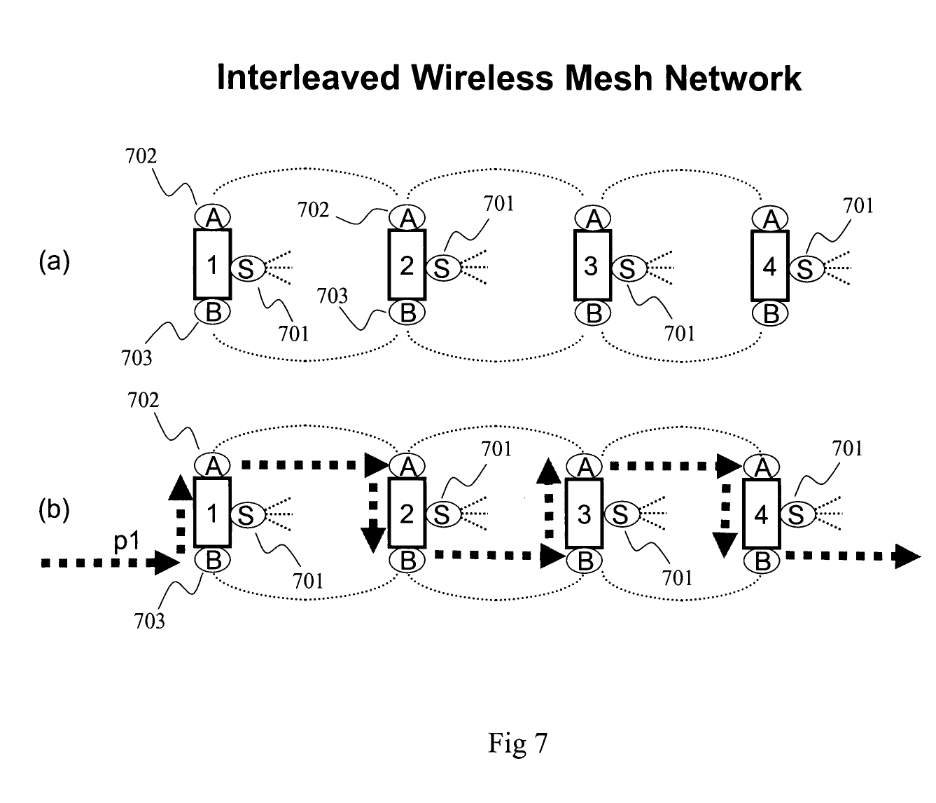

FIG. 7 is essentially identical to FIG. 6 but adds the functionality of a service or AP (access point) radio 701 which has been added to each mesh node. As embodied in a variety of prior art mesh architectures including FIGS. 1(c) and (d), having a separate service radio enables the relay radios 702 and 703 to operate on different channels (frequencies) than the service radio. Also, having a separate service radio provides for simultaneous operation of relay and service radios thus increasing overall performance.

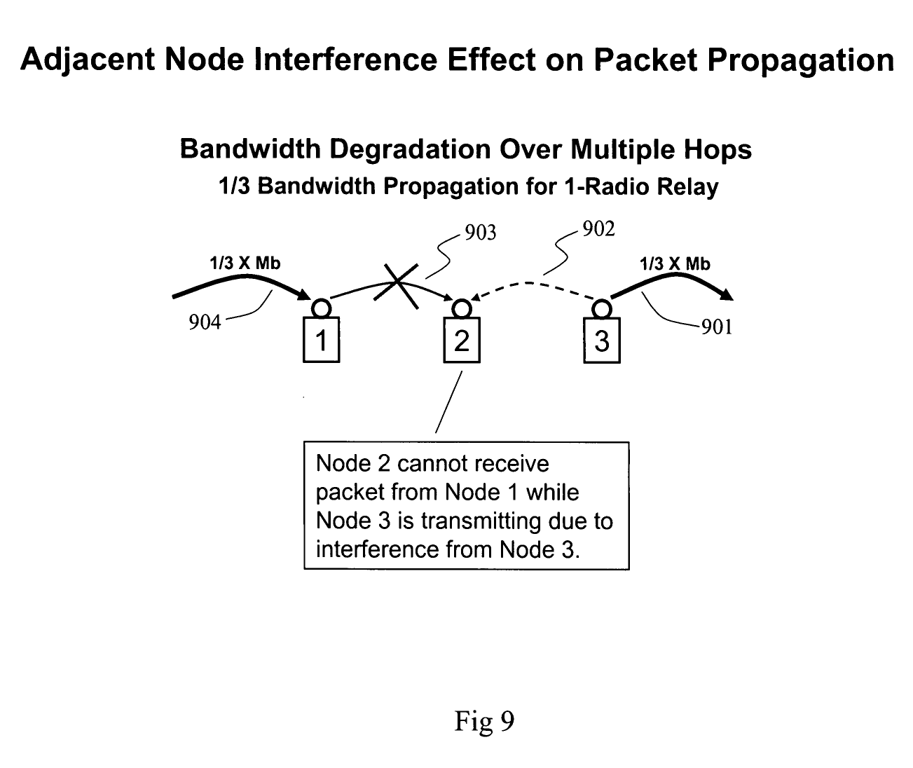

FIG. 8 shows examples of packet propagation scenarios through an interleaved or ping-pong mesh. Three scenarios are shown, (a), (b), and (c) for the propagation of sequential packets p1 through p4. For each scenario, packet propagation is shown for three sequential time slots, T1, T2, and T3. For the description of FIG. 8, adjacent node interference effects are temporary ignored to allow a simpler initial explanation of packet propagation. These effects will be explained in FIG. 9 and then incorporated into the packet propagation description in FIG. 10.

Timeslot T1 of scenario (a) in FIG. 8 shows packet p1 leaving node 801 and traveling to node 802 by way of the channel A mesh. Continuing scenario (a), timeslot T2 shows packet p1 progressing from node 802 to node 803, but this time propagating by way of the B-channel mesh. Concurrent with the propagation of packet p1 just described, packet p2 propagates from node 801 to node 802 on the A-channel mesh, thus demonstrating the ability of interleaved mesh nodes to simultaneously transmit and receive. Continuing scenario (a) further, timeslot T3 shows packet p1 and p2 progressing further, having “ping-ponged” to the opposite mesh, while packet p3 now enters the propagation stream 804 following p1 and p2 in sequence. Thus, it is also demonstrated that while packets in an interleaved or ping-pong mesh may travel on either of the multiple meshes for any given hop, the sequence of the packet stream is maintained such that the overall functionality is essentially the same as if only a single mesh had been used, except that performance has been increased due to simultaneity of transmission.

Scenario (b) of FIG. 8 demonstrates that sequential packets p1 and p2 may actually propagate simultaneously, each on a different mesh, even though in the packet stream, packet p1 precedes p2. Notice that in timeslot T2, packets p1 and p2 propagate simultaneously from node 802 to node 803, and that during this timeslot, no packets propagate from node 801 to node 802. This is due to the fact that the channel A and channel B radios 805 and 806 respectively cannot receive packets while they are transmitting packets. Subsequently in timeslot T3, packets p3 and p4 propagate simultaneously from node 801 to node 802, while packets p1 and p2 propagate simultaneously from node 803 onward.

Scenario (c) demonstrates that it is not required for a packet to utilize multiple meshes in the interleaved scheme. A packet can propagate solely on one mesh if the mesh control software in the various nodes decides that this is appropriate under the particular circumstances. This choice could relate to traffic patterns and also to interference effects. In timeslot T1 of scenario (c), packet p1 propagates from node 801 to node 802 via the A-channel mesh. In timeslot T2 of scenario (c), packet p1 further propagates from node 802 to node 803, also via the A-channel mesh. In timeslot T3 of scenario (c), packet p1 propagates beyond node 803 to another node in the mesh, also via the A-channel mesh.

As described above, it has been demonstrated that a sequential stream of packets can be propagated faster through an interleaved mesh architecture compared with architectures having a single radio relay structure. As dictated by the current traffic situation, two sequential packets may be propagated in sequence on one mesh of the multiple available interleaved meshes, or alternately these same two sequential packets may be propagated simultaneously on different meshes within the multiple available meshes. In some embodiments, it is necessary that these sequential packets are delivered to their final destination in proper sequence and hence it may be necessary to provide a buffer memory on the receiving side such that when packets are transmitted in parallel and received out of sequence, the proper sequence can be restored. This restoration of the packet sequence is performed by the controlling software in the receiving node which upon examining the identification field in the IP header of each packet, determines the proper sequence of packets stored in the buffer. Thus, the multiple meshes within an interleaved mesh architecture according to this invention are able to propagate a stream of sequential packets at a rate at least double the rate of a prior art mesh with single radio relay capability. Note that while a prior art system that might utilize two parallel RF links between two adjacent nodes for a “full-duplex” link can increase aggregate bandwidth by a factor of two for all traffic, a particular stream of packets would travel through one of these two parallel RF links, and thus that particular packet stream would propagate at the same rate it would in a mesh with a single radio relay.

In reality, if omnidirectional antennas are used, the scenarios of FIG. 8 would look somewhat different when interference effects of adjacent nodes are further taken into account. These effects are described in more detail in FIG. 9. Here node 3 is transmitting 901 a packet to a node elsewhere on the mesh network, and while it is transmitting in this desired direction, as a result of using an omnidirectional antenna, the packet is also being transmitted in the opposite (undesired) direction 902 back towards node 2. Thus, while it would be desirable for node 2 to receive a packet from node 1 while node 3 is transmitting, such a packet transfer 903 is not possible and thus is shown with a “X” through it. As a result, node 1 is not able to transmit to node 2 but is able to receive 904 from some other node in the mesh network simultaneously with the transmission 901 from node 3. The result of this interference effect is that when examining a pipelined propagation of packets through a mesh with a 1-radio relay, only every third timeslot will actually propagate a packet, resulting in an actual propagated bandwidth of ⅓ that which the radios themselves are able to transmit and receive. Since this is a pipelined effect, after 4 hops the effect remains stable and the bandwidth degradation consistent. Of course most mesh installations are 2-dimensional topologies, not 1-dimensional as shown here for clarity. A 2-dimensional mesh will have further interference effects regardless of the architecture chosen. In the interleaved mesh according to this invention, much of this adjacent node degradation effect just described is offset by using multiple interleaved meshes to increase the simultaneity of packet propagation. In other words, by sending a packet stream simultaneously over two or more parallel meshes, the present invention can increase the overall effective propagation rate of a packet stream from the one third rate just described to a rate equal to two thirds or better of that which the radios themselves are able to transmit and receive. Note that the effect just described in FIG. 9 is the result of omnidirectional antennas which transmit in all directions, not just the desired direction. The use of directional or sector antennas can reduce or minimize the interference effects of FIG. 9, however omnidirectional antennas may still be preferable in a variety of settings, such as when used in the context of mobile nodes.

For mobile mesh applications such as police, fire department, and other first responders, as well as military applications, directional antennas are sometimes impractical and omnidirectional antennas must be utilized in spite of the limitations. Thus, FIG. 10 further describes packet propagation through an interleaved mesh specifically when omnidirectional antennas are utilized and adjacent node interference effects are present.

For scenario (a) in FIG. 10, timeslots T1 and T2 show packet propagation similar to scenario (a) of FIG. 8. In timeslot T3, a packet is unable to be transmitted 1001 from node 1002 to node 1003 due to interference 1004 from A-channel radio 1005 attempting to transmit 1006 packet p1 onward through the mesh. Packet p3 is finally able to propagate from node 1002 to node 1003 during timeslot T4. Notice that interfering transmissions 1007 and 1008 during timeslot T4 further impede packet propagation.

Scenario (b) in FIG. 10 starts with packets P1 and P2 being transmitted simultaneously during timeslot T1 from node 1002 to node 1003 on meshes A and B respectively within the interleaved mesh. During timeslot T2, these packets propagate further from node 1003 to node 1009. During timeslot T3, it would be desirable for packets p3 and p4 to be transmitted from node will 1002 to node 1003, however this is prevented by interference radiations 1010 and 1011 resulting from the transmission of p1 and p2 as shown. Finally, in timeslot T4, packets p3 and p4 are able to propagate from node 1002 to node 1003. Note that in scenario (b) of FIG. 10, packets P1 and P2 are transmitted simultaneously even though they are adjacent sequential packets in a particular packet stream. Thus, this particular packet stream is able to propagate at twice the rate that it would in a system with a conventional single radio relay, thereby increasing effective propagation rate of a single packet stream to at least ⅔ of that which the radios themselves are able to transmit and receive, when two parallel meshes are used for an interleaved scenario. This performance level includes the interference effects described for FIGS. 9 and 10.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps preformed in the embodiments of the invention disclosed can be performed in alternate orders, certain steps can be omitted, and additional steps can be added. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

What is claimed is:

1. An interleaved wireless mesh network, comprising:
a plurality of mesh nodes, each node having at least a first radio and a second radio wherein the first radio of a first node in the plurality of nodes is adapted to communicate with the first radio of an adjacent node via a specific first channel and the second radio of the first node is adapted to communicate with the second radio of the adjacent node via a specific second channel; and
wherein a first packet from a sequential stream of internet protocol (IP) packets is transmitted from the first radio of the first node to the first radio of the adjacent node via the first channel; and
wherein a second packet that is adjacent to the first packet in the same sequential stream is transmitted from the second radio of the first node to the second radio of the adjacent node via the second channel.

2. The interleaved wireless mesh network of claim 1 wherein the first radio of the first node is adapted to communicate with the first radio of every adjacent node via the first channel and wherein the second radio of the first node is adapted to communicate with the second radio of every adjacent node via the second channel.

3. The interleaved wireless mesh network of claim 1 wherein the first packet is transmitted from the first node to the adjacent node simultaneously with the second packet.

4. The interleaved wireless mesh network of claim 1 wherein the first packet is transmitted from the first node to the adjacent node before the second packet.

5. The interleaved wireless mesh network of claim 1 wherein the first radio of the first node is adapted to receive a packet while the second radio of the first node is simultaneously transmitting a different packet.

6. The interleaved wireless mesh network of claim 1 wherein the first node detects radar interference on a first RF channel and transmits instructions to the plurality of nodes to perform dynamic frequency selection (DFS) and to switch to a third RF channel, whereby the first radio of each node switches from the first RF channel to the third RF channel.

7. The interleaved wireless mesh network of claim 6 wherein the plurality of nodes continue receiving and transmitting packets on the second RF channel uninterrupted by the DFS while switching to the third RF channel.

8. The interleaved wireless mesh network of claim 1 wherein the second packet is received on the first radio of the first node before being transmitted on the second radio of the first node to the adjacent node.

9. The interleaved wireless mesh network of claim 1 wherein each node is aware of all other nodes in the network, the number of meshes available and is further aware of said first and second channel that the meshes utilize, such that an optimum routing path can be computed for each packet in the sequential stream.

10. The interleaved wireless mesh network of claim 1 wherein alternative parallel paths are provided for propagating a packet from any node in the plurality of mesh nodes to any adjacent node.

11. A method of transmitting data packets over multiple hops, comprising:
maintaining an interleaved wireless mesh network including a plurality of mesh nodes, each node having at least a first radio and a second radio wherein the first radio is adapted to communicate with the first radio of every adjacent node via a specific first channel and wherein the second radio is adapted to communicate with the second radio of every adjacent node via a specific second channel;
receiving a first packet in a sequential stream of internet protocol (IP) packets to a first node in the plurality of nodes;
transmitting the first packet from the first node to a second adjacent node via the specific first channel;
receiving a second packet in the same sequential stream of IP packets to the first node; and
transmitting the second packet from the first node to the second adjacent node via the specific second channel.

12. The method of claim 11 wherein the first packet is received to the first node on the second radio and the second packet is received to the first node on the first radio.

13. The method of claim 11 wherein the first packet is transmitted from the first node to the adjacent node simultaneously with the second packet.

14. The method of claim 11 wherein the first packet and the second packet are adjacent packets in the same sequential stream.

15. The method of claim 11 wherein the second radio of the first node is adapted to receive the second packet while the first radio of the first node is simultaneously transmitting the first packet.

16. The method of claim 11, further comprising:
detecting radar interference on the first channel by the first node; and
transmitting instructions to the plurality of nodes by the first node, said instructions including a command to perform dynamic frequency selection (DFS) operation and to switch from the first channel to a specific third channel.

17. The method of claim 16, further comprising:
continuing to propagate network traffic via the second channel while the plurality of nodes switch from the first channel to the third channel.

18. The method of claim 11, further comprising:
receiving the first packet to the second adjacent node via the first channel;
transmitting the first packet from the second adjacent node to a third node via the second channel wherein said third node is adjacent to the second adjacent node but is not adjacent to the first node;
receiving the second packet to the second adjacent node via the second channel; and
transmitting the second packet from the second adjacent node to the third node via the first channel.

19. The method of claim 11 wherein each node in said interleaved wireless mesh network is aware of all other nodes in the network, the number of meshes available and is further aware of said first and second channel that the meshes utilize, such that an optimum routing path can be computed for each packet in the sequential stream.

20. The method of claim 11 wherein alternative parallel paths are provided for propagating a packet from any node in the mesh network to any adjacent node.

21. A method for executing a dynamic frequency selection (DFS) operation in an interleaved wireless mesh network, said network comprising a plurality of mesh nodes, each mesh node having at least two relay radios where each relay radio makes RF connections to radios on all adjacent nodes by way of a specific RF frequency or channel, wherein a first relay radio on each node connects to all adjacent nodes via a specific first channel, and a second relay radio on each node connects to all adjacent nodes via a specific second channel, said method comprising the steps of:
sensing radar interference at a sensing node on said first specific channel utilized by said first relay radio;
transmitting a command from said sensing node to all other nodes in said interleaved wireless mesh network indicating that a DFS operation is required and that all first relay radios on each node must change to operate henceforth on a specific third channel; and
continuing to propagate network traffic by way of said second relay radio on each of said mesh nodes while said first relay radios change channels in order to operate on said specific third channel.

22. The method of claim 20 wherein each node in said interleaved wireless mesh network is aware of all other nodes in the network, the number of meshes available and is further aware of said first and second channel that the meshes utilize.
